(19) United States
(12) Patent Application Publication
(10) Pub. No.: US 2017/0327700 A1
(43) Pub. Date: Nov. 16, 2017

(54) COMPOSITION WHICH FORMS AN INSULATING LAYER AND USE OF SAID COMPOSITION

(71) Applicant: HILTI AKTIENGESELLSCHAFT, Schaan (LI)

(72) Inventors: Jekaterina JEROMENOK, Ostfildern (DE); Juliane MARAUSKA, Kaltenkirchen (DE)

(21) Appl. No.: 15/531,872

(22) PCT Filed: Dec. 1, 2015
(86) PCT No.: PCT/EP2015/078123

§ 371 Date: May 31, 2017

(30) Foreign Application Priority Data
Dec. 4, 2014 (EP) 14196202.7

(51) Int. Cl. C09D 5/18; C08G 18/38; C08G 18/50; C09K 21/10; C08G 18/73

(52) U.S. Cl. CPC C09D 5/185; C09K 21/10; C08G 18/73; C08G 18/3821; C08G 18/5024; C08G 18/3876; C08G 2150/60

(57) ABSTRACT

The invention relates to a composition which forms an insulating layer and which contains a binder based on polyurea. The inventive composition, which has a relatively high expansion rate, allows application, in a simple and rapid manner, of coatings having the layer thickness required for the particular fire resistance time, it being possible to reduce the layer thickness to a minimum and nevertheless to achieve high insulating action. The inventive composition is particularly suitable for fire protection, especially as a coating for metallic and nonmetallic substrates, for instance steel components such as pillars, beams and bars, for increasing the fire resistance time.

The present invention relates to a composition, which forms an insulating layer, in particular a composition having intumescent properties, containing a binder based on polyurea, as well as use thereof for fire prevention, in particular for coatings on components such as pillars, beams and bars, to increase the fire resistance time.

Compositions, which form an insulating layer, also known as intumescent compositions, are usually applied in order to form coatings on the surface of components to protect them from fire or from high exposure for example due to a fire. In the meantime, steel constructions have become an element in modern architecture, even though they have a significant disadvantage in comparison with steel-reinforced concrete structures. Above approx. 500° C., the load carrying capacity of steel drops by 50%, i.e., steel loses a large portion of its stability and load carrying capacity. This temperature can be reached after about 5 to 10 minutes of direct exposure to fire (approx. 1000° C.), depending on the fire load, and this often results in a loss of load bearing capacity of the construction. The goal of fire prevention, in particular prevention of fires with steel, is now to delay the period of time until a steel construction loses its load bearing capacity in the event of a fire in order to be able to save human lives and valuable property for as long as possible.

The construction regulations in many countries therefore require corresponding fire resistance times for certain constructions made of steel. These fire resistance times are defined by so-called F classes such as F 30, F 60, F 90 (fire resistance classes according to DIN 4102-2) or US classes according to ASTM, etc., wherein according to DIN 4102-2, for example, F 30 means that, in the event of a fire, a load bearing steel construction must be able to withstand fire for at least 30 minutes under normal conditions. This is usually achieved by delaying the heating rate of the steel, for example, by coating the steel construction with coatings that form insulation layers. These are paints whose components create foam in the event of a fire, i.e., forming a solid microporous carbon foam. This produces a thick but fine-pored foam layer, the so-called ash crust, which forms a strong thermal insulation layer, depending on the composition, and thereby delays the heating of the component, so that the critical temperature of approx. 500° C. is reached after 30, 60, 90, 120 minutes at the soonest or up to 240 minutes. The applied layer thickness of the coating and/or the ash crust, which develops from it, is essential for the fire resistance that is to be achieved. Closed profiles such as pipes require approximately twice as much foam with a comparable solidity in comparison with open profiles, such as beams with a double T profile. In order in order to maintain the required fire resistance times, the coatings must have a certain thickness and the ability to form the most voluminous possible ash crust, which will thus provide good insulation in the event of heat exposure and which will maintain mechanical stability over the duration of the fire stress.

Therefore, various systems are known in the state of the art. A distinction is made essentially between 100% systems and water-based or solvent-based systems. With the water-based and/or solvent-based systems, binders, usually resins, are applied in the form of a solution, dispersion or emulsion to the component. These may be embodied as single-component or multicomponent systems. After application, the solvent and/or the water evaporate(s), leaving behind a film that dries over time. Furthermore, a distinction can also be made between such systems, in which the coating essentially no longer changes during drying, and systems in which curing of the binder is induced after evaporation, primarily due to oxidation and polymerization reactions, which are induced by the atmospheric oxygen, for example. The 100% systems contain the components of the binder without any solvent or water. They are applied to the component, and the “drying” of the coating takes place only through reaction of the binder components.

Systems based on solvents or water have the disadvantage that the drying times, also referred to as curing times, are long and also several layers must be applied, i.e., several operations are required to achieve the necessary layer thickness. Since each individual layer must be dried accordingly before the next layer is applied, this results in a great expenditure in terms of labor time and high costs accordingly, as well as a delay in completion of the construction because, depending on the climate conditions, sometimes it takes several days for the required layer thickness to be applied. It is also a disadvantage that, due to the necessary layer thickness, the coating may have a tendency to crack or flake off during the drying or with heat exposure, so that, in the worst case, the substrate may even be partially exposed, in particular with systems in which the binder does not harden subsequently after evaporation of the solvent and/or water.

To eliminate this disadvantage, two-component or multicomponent systems based on epoxy and amine that require almost no solvent have been developed, so that curing can take place much more rapidly, and furthermore, thicker layers can be applied in one operation, so that the required layer thickness is built up much more rapidly. However, these systems have the disadvantage that the binder forms a very stable and rigid polymer matrix, often with a large softening range, which interferes with the formation of foam by the foam-forming agent. Therefore, thick layers must be applied to produce a sufficient foam thickness for the insulation. This is in turn a disadvantage because it requires a great deal of material. In order to be able to apply these systems, processing temperatures up to +70° C. are often necessary, which makes the application of these systems labor-intensive and expensive in the installation.

The unpublished European Patent Application EP 13170748 describes a system, which forms an insulation layer on the basis of polyureas. The disadvantage of this chemically curing system is a curing time in the range of a few hours to a day.

The object of the present invention is to create a composition, which forms an insulation layer for coating systems of the type mentioned above, which will avoid the aforementioned disadvantages, and which will not be based on solvents or water in particular and will have a rapid curing by being easy to apply because of a suitably tailored viscosity and requiring only a small layer thickness because of the good intumescence rate that can be achieved, i.e., formation of an effective ash crust layer. Furthermore, the invention is also based on the object of not having a negative effect on the fire prevention properties of the system described in the unpublished European Patent Application EP 13170748, in particular with regard to the intumescence factor and the composition of the ash crust, but instead to improve the handling thereof.

This object is achieved by the composition according to claim 1. Preferred embodiments can be derived from the dependent claims.

The subject matter of the invention is thus a composition, which forms an insulation layer with component A containing an isocyanate compound with a component B containing a reactive component that is reacted with isocyanate compounds and is selected from compounds containing at least two amino groups, the amino groups being primary and/or secondary amino groups independently of one another, with a component C containing a thiol-functionalized compound and with a component D containing an additive that forms an insulation layer, the additive forming an insulation layer comprising a mixture, which contains optionally at least one carbon source, at least one dehydration catalyst and at least one blowing agent. This is not a foam system, which will foam in the absence of heat exposure, but instead it forms a thin unfoamed layer after curing, i.e., after the corresponding components have reacted with one another, and this layer does not begin to foam until it is exposed to heat, as in the event of a fire.

Due to the composition according to the invention, coatings with the layer thickness required for the respective fire resistance time can be applied easily and quickly. The advantages achieved by the invention can be seen essentially in that the curing times can be shortened significantly in comparison with other known systems, such as systems based on solvents or water and/or polyurea, which therefore greatly reduces the labor time. Because of the low viscosity of the composition in the application range, which is adjusted by means of suitable thickener systems, application without the heating the composition is possible in contrast with epoxy-amine systems, e.g., due to the widely used airless spray method for example.

Because of the lower softening range of the polymer matrix in comparison with the systems based on epoxy amine, the intumescence is relatively high with regard to the expansion rate so that a great insulating effect is achieved, even with thin layers. The possible high filling degree of the composition with fire prevention additives also contributes to this and can also be achieved by the fact that, among other things, the composition can be fabricated as a two-component or multicomponent system. Accordingly, the consumption of materials is reduced, which has a positive effect on the cost of materials, in particular in the case of application over a large area. This is achieved in particular by using a reactive system that does not undergo physical drying and therefore does not suffer a loss of volume due to the drying of solvents or, in the case of water-based systems, the loss of water, but instead the curing takes place through polyaddition. Thus, in a traditional system, a solvent content of approx. 25% is typical, but with the composition according to the invention, more than 95% of the coating remains on the substrate to be protected. Furthermore, the relative stability of the ash crust due to the advantageous structure of the foam formed in the event of a fire is very high.

In comparison with solvent-based or water-based systems, when they are applied without a primer the compositions according to the invention have excellent adhesion to a variety of metallic and nonmetallic substrates as well as an excellent cohesion and impact resistance.

For a better understanding of the invention, the following explanations of the terminology used herein are considered relevant. In the sense of the present invention:

the term “forming an insulation layer” means that the cured unfoamed composition will foam up in the event of a fire and form an insulating carbon foam (ash crust); therefore, “composition, which forms an insulation layer” means that the composition foams only under the influence of elevated temperatures, e.g., in the event of a fire; “forming an insulation layer” is therefore equivalent to “forming an insulation layer in the event of a fire”;

the term “aliphatic compound” comprises cyclic and acyclic, saturated and unsaturated hydrocarbon compounds, which are not aromatic (PAC, 1995, 67, 1307; Glossary of class names of organic compounds and reactivity intermediates based on structure (IUPAC Recommendations, 1995));

“polyamine” refers to a saturated open-chain or cyclic organic compound, which is interrupted by a varying number of secondary amino groups (—NH—) and has primary amino groups (—NH2) on the chain termini, in particular in the case of the open-chain compounds;

“organic radical” refers to a hydrocarbon radical which may be saturated or unsaturated, substituted or unsubstituted, aliphatic, aromatic or araliphatic; wherein “araliphatic” means that both aromatic and aliphatic radicals are present;

“multifunctional” means that the corresponding compound has more than one functional group per molecule; accordingly, the term “multifunctional” in conjunction with epoxy compounds means that they have more than one epoxy group per molecule and, with respect to thiol-functionalized compounds, means that they have at least two thiol groups per molecule; the total number of respective functional groups is the functionality of the corresponding compounds;

“backbone” of the epoxy resin or the thiol-functionalized compound refers to the other part of the molecule to which the functional epoxy or thiol group may be bound;

an “oligomer” is a molecule with 2 to 5 repeating units and a “polymer” is a molecule with 6 or more repeating units and may have structures that are linear, branched, stellate, coiled, hyperbranched or crosslinked; polymers may have a single type of repeating unit (“homopolymers”) or they may have more than one type of repeating units (“copolymers”); the term “resin” as used herein is a synonym for polymer;

“chemical intumescence” refers to the formation of a voluminous insulating ash layer by coordinated compounds, which react with one another on exposure to heat;

“physical intumescence” refers to the formation of a voluminous insulating layer by expanding a compound, which releases gases on exposure to heat without any chemical reaction between two compounds, so that the volume of the compound is increased by a multiple of the original volume;

“forming an insulation layer” means that a solid, microporous carbon foam is formed in the event of a fire, so that the resulting thick and fine-pored foam layer, the so-called ash crust, insulates a substrate from heat, depending on the composition;

a “carbon source” is an organic compound, which leaves behind a carbon backbone due to incomplete combustion and will not burn completely to form carbon dioxide and water (carbonization); these compounds are also referred to as “carbon backbone forming compounds”;

an “acid-forming substance” is a compound which forms a nonvolatile acid when exposed to heat, i.e., at temperatures above approx. 150° C., due to decomposition, for example, and therefore acts as a catalyst for carbonization; furthermore, it can contribute to the reduction in viscosity of the melt of the binder, so the term “dehydration catalyst” is used as equivalent to this;

a “blowing agent” is a compound which decomposes at an elevated temperature, releasing inert, i.e., nonflammable, gases and causing the carbon backbone formed by carbonization and optionally the softened binder to expand into a foam (intumescence); this term is equivalent to “gas-forming substance”;

an “ash crust stabilizer” is a so-called backbone-forming compound, which stabilizes the carbon backbone (ash crust) that is formed from the interaction of the formation of carbon from the carbon source and the gas from the blowing agent or the physical intumescence. The basic mechanism of action is that the essentially very soft carbon layers that are formed are solidified mechanically by inorganic compounds; addition of such an ash crust stabilizer contributes to a substantial stabilization of the intumescence crust in the event of a fire because these additives increase the mechanical strength of the intumescence crust in the event of a fire because these additives increase the mechanical strength of the intumescent layer and/or prevent it from dripping off, so that the insulating effect of the foam is maintained or increased.

The isocyanate compound (component A) to be used may include all the aliphatic and/or aromatic isocyanates known to those skilled in the art and having an average NCO functionality of one or more, preferably more than two, used individually or in any mixture with one another.

Examples of aromatic polyisocyanates include 1,4-phenylenediisocyanate, 2,4- and/or 2,6 toluylenediisocyanate, xylylene diisocyanate, hydrogenated xylylene diisocyanate, tetramethylxylylene diisocyanate, 1,5-naphthylene diisocyanate, diphenylenemethane 2,4′- and/or 4,4′-diisocyante, triphenylmethane 4,4′,4″-triisocyanate and bis- and tris-(isocyanatoalkyl)benzenes, -toluenes as well as -xylenes.

Isocyanates from the series of aliphatic representatives are preferred, where these have a basic carbon backbone (not including the NCO groups they contain) of 3 to 30, preferably 4 to 20 carbon atoms. Examples of aliphatic polyisocyanates include bis(isocyanatoalkyl) ethers or alkane diisocyanates, such as propane diisocyanates, butane diisocyanates, pentane diisocyanates, hexane diisocyanates (e.g., hexamethylene diisocyanate, HDI), heptane diisocyanates, octane diisocyanates, nonane diisocyanates (e.g., trimethyl-HDI (TMDI) usually as a mixture of the 2,4,4- and the 2,2,4-isomers), 2-methylpentane 1,5-diisocyanate (MPDI), nonane triisocyanates (e.g., 4-isocyanatomethyl 1,8-octane diisocyanate), decane diisocyanates, decane triisocyanates, undecane diisocyanates, undecane triisocyanates, dodecane diisocyanates, dodecane triisocyanates, 1,3- and 1,4 bis(isocyanato [symbol] methyl) [symbol] cyclohexane (H6XDI), 3-isocyanatomethyl-3,5,5-trimethylcycohexyl isocyanate (isophorone diisocyanate, IPDI), bis(4-isocyanatocyclohexyl)methane (H12MDI), bis(isocyanatomethyl) [symbol] norbornane (NBDI) or 3(4)-isocyanatomethyl-1-methylcyclohexyl isocyanate (IMCI).

Especially preferred isocyanates include hexamethylene diisocyanate (HDI), trimethyl-HDI (TMDI), 2-methylpentane 1,5-diisocyanate (MPDI), isophorone diisocyanate (IPDI), 1,3- and 1,4-bis(isocyanatomethyl)cyclohexane (H6XDI), bis(isocyanatomethyl)norbornane (NBDI), 3(4)-isocyanatomethyl-1-methylcyclohexyl isocyanate (IMCI) and/or 4,4′-bis(isocyanato-cyclohexyl)methane (H12MDI) or mixtures of these isocyanates.

Even more preferred are the polyisocyanates as prepolymers, biurets, isocyanurates, iminooxadiazinediones, uretdiones and/or allophanates prepared by reaction with polyols or polyamines, individually or as a mixture, and have an average functionality of one or more, preferably two or more.

Examples of suitable isocyanates available commercially include Desmodur® N 3900, Desmodur® N 100, Desmodur® N 3200, Desmodur® N 3300, Desmodur® N 3600, Desmodur® N 3800, Desmodur® XP 2675, Desmodur® 2714, Desmodur® 2731, Desmodur® N 3400, Desmodur® XP 2580, Desmodur® XP 2679, Desmodur® XP 2731, Desmodur® XP 2489, Desmodur® E 305, Desmodur® E 3370, Desmodur® XP 2599, Desmodur® XP 2617, Desmodur® XP 2406, Desmodur® VL, Desmodur® VL 50, Desmodur® VL 51 (each from Bayer Material Sciences AG), Tolonate HDB, Tolonate HDT (Rhodia), Basonat HB 100 and Basonat Hl 100 (BASF).

The amines (component B) that can be used as a reactive component for reacting with isocyanate compounds include all compounds having at least two amino groups, wherein the amino groups are primary and/or secondary amino groups capable of reacting with isocyanate groups to form a urea group (—N—C(O)—N—), wherein these compounds are familiar to those skilled in the art.

In one embodiment of the invention, the reactive component that reacts with isocyanate compounds is a polyamine, such as, for example, 1,2-diaminocyclohexane, 4,4′ diaminodiphenylsulfone, 1,5-diamino-2-methylpentane, diethylene triamine, hexamethylene diamine, isophorone diamine, triethylene tetramine, trimethylhexamethylene diamine and 5-amino-1,3,3-trimethylcyclohexane-1-methylamine.

These polyamines are highly reactive with isocyanate groups, so that the reaction between the amino group and the isocyanate group takes place within a few seconds.

Therefore, compounds that react less quickly with the isocyanate groups such as the so-called polyether polyamines are preferred. Polyether polyamines, also known as alkoxylated polyamines or polyoxyalkene polyamines include compounds with aliphatically bound amino groups, i.e., the amino groups are bound to the termini of a polyether backbone. The polyether backbone is based on pure or mixed polyalkylene oxide units such as polyethylene glycol (PEG), polypropylene glycol (PPG). The polyether backbone can be obtained by reacting a di- or trialcohol initiator with ethylene oxide (EO) and/or propylene oxide (PO) and then converting the terminal hydroxyl groups to amino groups.

Suitable polyether polyamines are represented by the following general formula (I)

where

R is the radical of an initiator for alkoxylation with 2 to 12 carbon atoms and 2 to 8 groups with active hydrogen atoms,

T stands for hydrogen or a C1-C4 alkyl group,

V and U, independently of one another, are hydrogen or T,

n is a value between 0 and 100,

m is an integer between 2 and 8, where m corresponds to the number of groups with an active hydrogen atom, which were originally present in the initiator for alkoxylation.

In additional embodiments, n has a value between 35 and 100 or less than 90, less than 80 and less than 70 or less than 60. In another embodiment, R denotes 2 to 6 or 2 to 4 or 3 groups with active hydrogens, in particular hydroxyl groups. In another embodiment R is an aliphatic initiator with several active hydrogens. In another embodiment, T, U and V are each methyl groups.

In this context, reference is made to U.S. Pat. No. 4,940,770 and the patent applications DE 26 09 488 A1 and WO 2012/030338 A1, the content of which is herewith included in the present patent application.

Examples of suitable polyether amines include the polyether amines of the D, ED, EDR and T series distributed by the Huntsman Corporation under the brand name JEFFAMINE®, where the D series includes diamines and the T series includes triamines, the E series includes compounds having a backbone consisting essentially of polyethylene glycol and the R series comprising highly reactive amines.

The products of the D series include amino-terminated polypropylene glycols of the general formula (II)

where x denotes a number with an average between 2 and 70. Commercially available products from the series include JEFFAMINE® D-230 (n˜2.5/mol. wt. 230), JEFFAMINE® D 400 (n˜6.1/mol. wt.=430), JEFFAMINE® D-2000 (n˜33/mol. wt. 2000) and JEFFAMINE® D-4000 (n˜68/mol. wt. 4000).

The products of the ED series include amino-terminated polyethers based on an essential polyethylene glycol backbone with the general formula (III):

where y denotes a number with an average between 2 and 40, and x+z denotes a number with an average between 1 and 6. Commercially available products form the series include: JEFFAMINE® HK511 (y=2.0; x+z˜1.2/mol. wt. 220), JEFFAMINE® ED-600 (y˜9.0; x+z˜3.6/mol. wt. 600), JEFFAMINE® ED-900 (y˜12.5; x+z˜6.0/mol. wt. 900) and JEFFAMINE® ED-2003 (y˜39; x+z˜6.0/mol. wt. 2000).

The products of the EDR series include amino-terminated polyethers with the general formula (IV)

where x is an integer between 1 and 3. Commercially available products from this series include JEFFAMINE® DER-148 (x=2/mol. wt. 148) and JEFFAMINE® DER-176 (x=3/mol. wt. 176).

The products of the T series include triamines obtained by reaction of propylene oxide with a triol initiator and then amination of the terminal hydroxyl groups and having the general formula (V) or isomers thereof:

where R denotes hydrogen or a C1 to C4 alkyl group, preferably hydrogen or ethyl, n is 0 or 1 and x+y+z corresponds to the number of moles of propylene oxide units, wherein x+y+z is an integer between approx. 4 and approx. 100, in particular between approx. 5 and approx. 85. Commercially available products from this series include JEFFAMINE® T-403 (R=C2H5; n=1; x+y+z=5-6/mol. wt. 440), JEFFAMINE® T-3000 (R=H; n=0; x+y+z=50/mol. wt. 3000) and JEFFAMINE® T-5000 (R=H; n=0; x+y+z=85/mol. wt. 5000).

Furthermore, the secondary amines of the SD and ST series are suitable, the SD series including secondary diamines and the ST series including secondary triamines obtained from the above series by reductive alkylation of the amino groups, in which the amino terminal groups are reacted with a ketone, e.g., acetone, and then reduced, so that sterically hindered secondary amino terminal groups with the general formula (VI) are obtained:

Commercially available products from this series include JEFFAMINE® SD-231 (starting material D230/mol. wt. 315), JEFFAMINE® SD-401 (starting material D-400/mol. wt. 515), JEFFAMINE® SD-2001 (starting material D-2000/mol. wt. 2050) and JEFFAMINE® ST-404 (starting product T-403/mol. wt. 565).

In a particularly preferred embodiment of the invention, polyaspartic acid esters, so-called polyaspartics, are used as the reactive component that reacts with isocyanate compounds, because their reactivity with isocyanate groups is greatly reduced in comparison with the reactivity of the other polyamines described above. This leads to the advantage that the processing time of a composition with an isocyanate component and a polyaspartic acid ester component is lengthened, which leads to a better ease of handling by the user. Furthermore, the use of polyaspartic acid esters results in compositions having a very low shrinkage. Therefore, thick films can be produced in only a few operations. Another advantage of using polyaspartic acid esters is manifested in the event of a fire because these compositions form a hard and very stable ash crust.

Suitable polyaspartic acid esters are selected from compounds of general formula (VII):

where R1 and R2 may be the same or different and stand for organic radicals that are inert with respect to isocyanate groups, R3 and R4 may be the same or different and stand for hydrogen or organic radicals that are inert with respect to isocyanate groups, X stands for an n-valent organic radical which is inert with respect to isocyanate groups, and n stands for an integer of at least 2, preferably of 2 to 6, more preferably of 2 to 4 and most preferably of 2. R1 and R2 preferably independently of one another stand for an optionally substituted hydrogen group, preferably a C1-C9 hydrocarbon group and more preferably a methyl group, an ethyl group or a butyl group, and R3 and R4 preferably each stand for hydrogen.

In one embodiment, X stands for an n-valent hydrocarbon group obtained by removing the amino groups from an aliphatic or araliphatic polyamine, preferably by removing the primary amino groups from an aliphatic polyamine, especially preferably a diamine. The term polyamine in this context comprises compounds having two or more primary amino groups and optionally additional secondary amino groups, wherein the primary amino groups are preferably in terminal position.

In a preferred embodiment, X stands for a radical such as that obtained by removing the primary amino groups from 1,4-diaminobutane, 1,6-diaminohexane, 2,2,4- or 2,4,4 trimethyl-1,6-diaminohexane, 1-amino-3,3,5-trimethyl-5-aminomethylcyclohexane, 4,4′ diaminodicyclohexylmethane or 3,3′-dimethyl-4,4′-diaminodicyclohexylmethane, diethylene triamine and triethylene tetramine and wherein n in formula (VII) stands for the number 2.

In this context, reference is made to the patent application EP 0 403 921 A2 and EP 0 743 332 A1 the contents of which are herewith incorporated into the present patent application.

Mixtures of polyaspartic acid esters can also be used.

Examples of suitable polyaspartic acid esters are distributed by Bayer Material Science AG under the brand name DESMOPHEN®. Commercially available products include for example DESMOPHEN® NH 1220, DESMOPHEN® NH 1420 and DESMOPHEN® NH 1520.

The reactive components that react with isocyanate compounds as described above may be used individually or as a mixture depending on the desired reactivity. In particular, the polyamines may serve as bridging compounds if they are used in addition to the polyether polyamines or the polyaspartic acid esters.

The quantity ratios of the components A and B are preferably selected so that the equivalent ratio of isocyanate groups of the isocyanate compound to the reactive groups (that react with the isocyanate group) of the reactive component that is reactive with isocyanate compounds is between 0.3 and 1.7, preferably between 0.5 and 1.5 and more preferably between 0.7 and 1.3.

It has surprisingly been found that the intumescence properties of the composition according to the invention can be improved, i.e., the intumescence factor can be increased if the degree of crosslinking of the product of the reaction of the polyaspartic acid ester and the polyisocyanate is reduced or at least polyol which can react with the isocyanate group to form a urethane group is added to the composition according to the invention as an additional component. This makes it possible to adjust the intumescence properties of the composition in a targeted manner through a suitable choice of polyols. It was also surprising that the stability of the ash crust was hardly affected at all by addition of a polyol.

The polyol is preferably used with the polyamine, polyether amine or polyaspartic acid ester in a ratio of OH:NH equals 0.05 eq:0.95 eq to 0.6 eq:0.4 eq, more preferably in a ratio of 0.1 eq:0.9 eq to 0.5 eq:0.5 eq and most preferably in a ratio of 0.2 eq:0.8 eq to 0.4 eq:0.6 eq.

The polyol is preferably constructed from a basic backbone of polyester, polyether, polyurethane and/or alkanes or mixtures of these with one or more hydroxyl groups. The basic backbone may be linear or branched and may contain the functional hydroxyl groups in a terminal position and/or along the chain.

More preferably, the polyester polyols are selected from the condensation products of di- and polycarboxylic acids, e.g., aromatic acids such as phthalic acid and isophthalic acid, aliphatic acids such as adipic acid and maleic acid, cycloaliphatic acids such as tetrahydrophthalic acid and hexahydrophthalic acid and/or their derivatives such as anhydrides, esters or chlorides, and an excess amount of polyfunctional alcohols, e.g., aliphatic alcohols such as ethanediol, 1,2-propanediol, 1,6-hexanediol, neopentyl glycol, glycerol, trimethylol propane and cycloaliphatic alcohols, such as 1,4-cyclohexanedimethanol.

In addition, the polyester polyols are selected from polyacrylate polyols such as copolymers of esters of acrylic acids and/or methacrylic acids, such as, for example, ethyl acrylate, butyl acrylate, methyl methacrylate and additional hydroxyl groups and styrene, vinyl esters and maleic acid esters. The hydroxyl groups in these polymers are introduced by way of functionalized esters of acrylic acid and methacrylic acid, e.g., hydroxyethyl acrylate, hydroxyethyl methacrylate and/or hydroxypropyl methacrylate.

In addition, the polyester polyols are also selected from polycarbonate polyols. Polycarbonate polyols that can be used are polycarbonates that have hydroxyl groups for example polycarbonate diols which can be obtained by reacting carbonic acid or carbonic acid derivatives with polyols or by copolymerization of alkylene oxides for example propylene oxide with CO2. Additionally, or alternatively, the polycarbonates that are used are constructed from linear aliphatic chains. Suitable carbonic acid derivatives include for example carbonic acid diesters such as diphenyl carbonate, dimethyl carbonate or phosgene. Suitable polyols include, for example, diols such as ethylene glycol, 1,2- and 1,3 propanediol, 1,3- and 1,4-butanediol, 1,6-hexanediol, 1,8-octanediol, neopentyl glycol, 1,4-bishydroxymethylcyclohexane, 2-methyl-1,3-propanediol, 2,2,4-trimethyl-1,3-pentane, dipropylene glycols, polypropylene glycols, dibutylene glycol, polybutylene glycols, bisphenol A and lactone-modified diols of the type defined above.

Instead of or in addition to pure polycarbonate diols, polyether polycarbonate diols may also be used.

In addition, the polyester polyols are selected from polycaprolactone polyols, produced by ring opening polymerization of ε-caprolactone with polyfunctional alcohols such as ethylene glycol, 1,2-propanediol, glycerol and trimethylolpropane.

More preferably, polyether polyols are also selected from the addition products of, for example, ethylene oxide and/or propylene oxide and polyfunctional alcohols, such as ethylene glycol, 1,2-propanediol, glycerol and/or trimethylolpropane.

Polyurethane polyols synthesized from polyaddition of diisocyanates with excess amounts of diols and/or polyols are even more preferable.

Furthermore, di- or polyfunctional alcohols selected from C2-C10 alcohols with the hydroxyl groups at the termini and/or along the chain are even more preferred.

The most preferred are the above-mentioned polyester polyols, polyether polyols and C2-C10 alcohols that are difunctional and/or trifunctional.

Examples of suitable polyester polyols include DESMOPHEN® 1100, DESMOPHEN® 1652, DESMOPHEN® 1700, DESMOPHEN® 1800, DESMOPHEN® 670, DESMOPHEN® 800, DESMOPHEN® 850, DESMOPHEN® VP LS 2089, DESMOPHEN® VP LS 2249/1, DESMOPHEN® VP LS 2328, DESMOPHEN® VP LS 2388, DESMOPHEN® XP 2488 (Bayer), K-FLEX XM-360, K FLEX 188, K-FLEX XM-359, K-FLEX A308 and K-FLEX XM-332 (King Industries).

Examples of suitable commercially available polyether polyols include: ACCLAIM® POLYOL 12200 N, ACCLAIM® POLYOL 18200 N, ACCLAIM® POLYOL 4200, ACCLAIM® POLYOL 6300, ACCLAIM® POLYOL 8200 N, ARCOL® POLYOL 1070, ARCOL® POLYOL 1105 S, DESMOPHEN® 1110 BD, DESMOPHEN® 1111 BD, DESMOPHEN® 1262 BD, DESMOPHEN® 1380 BT, DESMOPHEN® 1381 BT, DESMOPHEN® 1400 BT, DESMOPHEN® 2060 BD, DESMOPHEN® 2061 BD, DESMOPHEN® 2062 BD, DESMOPHEN® 3061 BT, DESMOPHEN® 4011 T, DESMOPHEN® 4028 BD, DESMOPHEN® 4050 E, DESMOPHEN® 5031 BT, DESMOPHEN® 5034 BT and DESMOPHEN® 5035 BT (Bayer) or blends of polyester polyols and polyether polyols such as WorleePol 230 (Worlee).

Examples of suitable alkanols include ethanediol, propanediol, propanetriol, butanediol, butanetriol, pentanediol, pentanetriol, hexanediol, hexanetriol, heptanediol, heptanetriol, octanediol, octanetriol, nonanediol, nonanetriol, decanediol and decanetriol.

According to the invention, the composition that forms insulating layers also contains a thiol-functionalized compound as the additional component C, wherein the thiol group (SH) forms the functional group. This yields faster curing.

Any compound having at least two thiol groups may expediently be used as the thiol-functionalized compound. Any thiol group is bound either directly to the backbone or by way of a linker.

The thiol-functionalized compound of the present invention may have any one of a wide variety of backbone structures, which may be the same or different.

According to the present invention, the backbone structure is a monomer, an oligomer or a polymer.

In some embodiments of the present invention, the backbone structures comprise monomers, oligomers or polymers with a molecular weight (mol. wt.) of 50,000 g/mol of 50,000 g/mol or less, preferably 25,000 g/mol or less, more preferably 10,000 g/mol or less, even more preferably 5000 g/mol or less, even more preferably 2000 g/mol or less and most preferably 1000 g/mol or less.

As monomers that are suitable as backbones, for example, alkanediols, alkylene glycols, sugars, polyvalent derivatives thereof or mixtures thereof and amines such as ethylene diamine and hexamethylene diamine and thiols may be mentioned. The following compounds may be mentioned as examples of oligomers or polymers that are suitable for use as the backbone: polyalkylene oxide, polyurethane, polyethylene vinyl acetate, polyvinyl alcohol, polydiene, hydrogenated polydiene, alkyd, alkyd polyester, (meth)acrylic polymer, polyolefin, polyester, halogenated polyolefin, halogenated polyester, polymercaptan as well as copolymers or mixture thereof.

In preferred embodiments of the invention, the backbone is a polyvalent alcohol or a polyvalent amine, wherein these may be monomeric, oligomeric or polymeric. Even more preferably, the backbone is that of a polyvalent alcohol.

The following examples may be given of polyvalent alcohols that are suitable as backbones: alkanediols such as butanediol, pentanediol, hexanediol, alkylene glycols such as ethylene glycol, propylene glycol and polypropylene glycol, glycerol, 2-(hydroxymethyl)propane-1,3-diol, 1,1,1-tris(hydroxymethyl)ethane, 1,1,1-trimethylol [symbol] propane, di(trimethylolpropane), tricyclodecane dimethylol, 2,2,4-trimethyl-1,3-pentanediol, bisphenol A, cyclohexane dimethanol, alkoxylated and/or ethoxylated and/or propoxylated derivatives of neopentyl glycol, tetraethylene glycol cyclohexanedimethanol, hexanediol, 2 (hydroxymethyl) [symbol] propane-1,3-diol, 1,1,1-tris(hydroxymethyl)ethane, 1,1,1-trimethylolpropane and castor oil, pentaerythritol, sugar, polyvalent derivatives thereof or mixtures thereof.

The linkers may be any units that are suitable for connecting the backbone to the functional groups. For thiol-functionalized compounds, the linker is preferably selected from the backbones (XIII) to (XVIII):

1: Binding to the functional group

2: Binding to the backbone

The structures (VIII), (IX), (X) and (XI) are especially preferred as linkers for thiol-functionalized compounds.

Especially preferred thiol-functionalized compounds include esters of α-thioacetic acid (2 mercaptoacetates), β-thiopropionic acid (3-mercaptopropionates) and 3-thiobutyric acid (3 mercaptobutyrates) with monoalcohols, diols, triols, tetraols, pentaols or other polyols as well as 2-hydroxy-3-mercaptopropyl derivatives of monoalcohols, diols, triols, tetraols, pentaols or other polyols. Mixtures of alcohols may also be used as the basis for the thiol-functionalized compound. Reference is made in this regard to WO 99/51663 A1, the content of which is herewith incorporated into the present patent application.

Especially suitable thiol-functionalized compounds that may be mentioned in particular include: glycol-bis(2-mercaptoacetate), glycol-bis(3-mercaptopropionate), 1,2-propylene glycol-bis(2-mercaptoacetate), 1,2-propylene glycol-bis(3-mercaptopropionate), 1,3 propylene glycol-bis(2-mercaptoacetate), 1,3-propylene glycol-bis(3-mercapto [symbol] propionate), tris(hydroxymethyl)methane-tris(2-mercaptoacetate), tris(hydroxymethyl) [symbol] methane-tris(3-mercaptopropionate), 1,1,1-tris(hydroxymethyl)ethane-tris(2-mercapto [symbol] acetate), 1,1,1-tris(hydroxymethyl)ethane-tris(3-mercaptopropionate), 1,1,1-trimethylol [symbol] propane-tris(2-mercaptoacetate), ethoxylated 1,1,1-trimethylolpropane-tris(2-mercapto [symbol] acetate), propoxylated 1,1,1-trimethylolpropane-tris(2-mercaptoacetate), 1,1,1-tri [symbol] methylolpropane-tris(3-mercaptopropionate), ethoxylated 1,1,1 trimethylolpropane-tris(3 [symbol] mercaptopropionate), propoxylated trimethylolpropane-tris(3-mercaptopropionate), 1,1,1 [symbol] trimethylolpropane-tris(3-mercaptobutyrate), pentaerythritol-tris(2-mercaptoacetate), pentaerythritol-tetrakis(2-mercaptoacetate), pentaerythritol-tris(3-mercaptopropionate), pentaerythritol-tetrakis(3-mercaptopropionate), pentaerythritol-tris(3-mercaptobutyrate), pentaerythritol-tetrakis(3-mercaptobutyrate), Capcure 3-800 (BASF), GPM-800 (Gabriel Performance Products), Capcure LOF (BASF), GPM-800L0 (Gabriel Performance Products), polythiol QE 340 M, KarenzMT PE-1 (Showa Denko), 2-ethylhexylthioglycolate, iso-octylthioglycolate, di(n-butyl)thiodiglycolate, glycol-di-3-mercaptopropionate, 1,6 hexane [symbol] dithiol, ethylene glycol-bis(2-mercaptoacetate) and tetra(ethylene glycol)dithiol.

The thiol-functionalized compound may be used alone or as a mixture of two or more different thiol-functionalized compounds.

Depending on the functionality of the thiol-functionalized compound, the degree of crosslinking of the binder and thus the strength of the resulting coating as well as its elastic properties can be adjusted.

For the case when the composition cures too slowly for the intended application, in particular when using polyaspartic acid esters, a tertiary amine may also be added to the composition as a catalyst.

Examples of such a tertiary amine catalysts include triethylamine, tributylamine, trioctylamine, monoethanolamine, diethanolamine, triethanolamine, triisopropanolamine, trimethylenediamine, quadrol, diethylenetriamine, dimethylaminopropylamine, N,N dimethylethanolamine, N-(3-dimethylaminopropyl)-N,N-diisopropanolamine, N methyl-morpholine, pentamethyldiethylenetriamine and/or triethylenediamine dimethylaniline, proton sponge, N,N′-bis[2-(dimethylamino)ethyl]-N,N′-dimethyl [symbol] ethylenediamine, N,N dimethylcyclohexylamine, N-dimethylphenylamine, 2 methyl [symbol] pentamethylenediamine, 2-methylpentamethylenediamine, 1,1,3,3 tetramethylguanidine, 1,3-diphenylguanidine, benzamidine, N-ethylmorpholine, 2,4,6 tris(dimethylamino [symbol] methyl)phenol (TDMAMP); DBU and DBN; n-pentylamine, n hexylamine, di-n-propylamine and ethylenediamine; DABCO, DMAP, PMDETA, imidazole and 1-methylimidazole or salts of amines and carboxylic acids and polyether amines such as polyether monoamines, polyether diamines or polyether triamines.

If the composition also contains polyols, then in the event the composition cures too slowly for the intended application, a catalyst selected from compounds tin, bismuth compounds, zirconium compounds, aluminum compounds or zinc compounds may be added to the composition. These preferably include tin octoate, tin oxalate, tin chloride, dioctyltin di-(2-ethylhexanoate), dioctyltin dithioglycolate, dibutyltin dilaurate, monobutyltin tris-(2-ethylhexanoate), dioctyltin dineodecanoate, dibutyltin dineodecanoate, dibutyltin diacetate, dibutyltin oxide, monobutyltin dihydroxychloride, organotin oxide, monobutyltin oxide, dioctyltin dicarboxylate, dioctyltin stannoxane, bismuth carboxylate, bismuth oxide, bismuth neodecanoate, zinc neodecanoate, zinc octoate, zinc acetylacetonate, zinc oxalate, zinc acetate, zinc carboxylate, aluminum chelate complex, zirconium chelate complex, dimethylaminopropylamine, N,N-dimethylcyclohexylamine, N,N dimethylethanol-amine, N-(3-dimethylaminopropyl)-N,N-diisopropanolamine, N-ethylmorpholine, N methyl morpholine, pentamethyldiethylenetriamine and/or triethylenediamine.

Examples of suitable catalysts include Borchi® Kat 24, Borchi® Kat 320, Borchi® Kat 15 (Borchers), TIB KAT 129, TIB KAT P129, TM KAT 160, TM KAT 162, TIB KAT 214, TM KAT 216, TM KAT 218, TIB KAT 220, TIB KAT 232, TM KAT 248, TM KAT 248 LC, TM KAT 250, TM KAT 250, TIB KAT 256, TIB KAT 318, TM Si 2000, TM KAT 716, TM KAT 718, TM KAT 720, TIB KAT 616, TIB KAT 620, TM KAT 634, TM KAT 635, TM KAT 815 (TIB Chemicals), K-KAT® XC-B221, K-KAT® 348, K-KAT® 4205, K-KAT® 5218, K-KAT® XK-635, K-KAT® XK-639, K-KAT® XK-604, K-KAT® XK-618 (King Industries), JEFFCAT® DMAPA, JEFFCAT® DMCHA, JEFFCAT® DMEA, JEFFCAT® DPA, JEFFCAT® NEM, JEFFCAT® NMM, JEFFCAT® PMDETA, JEFFCAT® TD-100 (Huntsman) and DABCO 33LV (Sigma Aldrich).

According to the invention, component D contains an additive that forms an insulation layer. This additive may comprise individual compounds or a mixture of several compounds.

The additives used as insulation layer-forming additives are expediently those that form an expanding insulating layer of a sparingly flammable material under the influence of heat. This layer protects the substrate from overheating and prevents or at least thereby delays the change in the mechanical and static properties of load bearing components due to exposure to heat. A voluminous insulating layer, namely an ash layer, can be formed due to the chemical reaction of a mixture of corresponding coordinated compounds which react with one another on exposure to heat. Such systems are known to those skilled in the art by the term “chemical intumescent system” and can be used according to the invention. Alternatively, the voluminous insulating layer can be formed by expanding a single compound, which releases gases on exposure to heat without any chemical reaction taking place between the two compounds. Such systems are known to those skilled in the art by the term “physical intumescence” and may also be used according to the invention. These two systems may each be used alone or in combination together according to the invention.

In general, at least three components are required to form an intumescent layer by chemical intumescence, i.e., a carbon source, a dehydration catalyst and a blowing agent which are present in a binder in coatings, for example. On exposure to heat, the binder escapes and the fire prevention additive are released so that they react with one another in the event of chemical intumescence or in the case of physical intumescence they may foam up. Due to thermal decomposition, the acid which, functions as the catalyst for the carbonification of the carbon source is formed from the dehydration catalyst. At the same time the blowing agent decomposes thermally, forming inert gases, which cause the carbonized (charred) material to expand and optionally also cause the softened binder to expand, forming a voluminous insulating foam.

In one embodiment of the invention, in which the insulating layer is formed by chemical intumescence, the additive forming the insulation layer comprises at least one carbon backbone forming substance if the binder cannot be used as such, at least one acid forming substance, at least one blowing agent and at least one inorganic backbone forming substance. The components of the additive are selected in particular so that they can form a synergism wherein some of the compounds may fulfill multiple functions.

The compounds generally used in intumescent fire prevention formulations that are familiar to those skilled in the art may be considered as the carbon source, such as starch-like compounds, e.g., starch and modified starch and/or polyvalent alcohols (polyols) such as saccharides, oligosaccharides and polysaccharides and/or a thermoplastic or thermosetting polymer resin binder such as a phenolic resin, a urea resin, a polyurethane, polyvinyl chloride, poly(meth)acrylate, polyvinyl acetate, polyvinyl alcohol, a silicone resin and/or a rubber. Suitable polyols include polyols from the group comprising sugar, pentaerythritol, dipentaerythritol, tripentaerythritol, polyvinyl acetate, polyvinyl alcohol, sorbitol, polyoxyethylene/polyoxypropylene (EO-PO) polyols. Pentaerythritol, dipentaerythritol or polyvinyl acetate are preferably used.

It should be pointed out that, in the event of a fire, the binder itself may also have the function of a carbon source.

Examples of dehydration catalysts and/or acid forming substances include the compounds known to those skilled in the art and generally used in intumescent fire prevention formulations, such as a salt or an ester of an inorganic nonvolatile acid, selected from sulfuric acid, phosphoric acid or boric acid. Essentially phosphorus compounds are used and there is a very great variety of such compounds because they extend over several oxidation stages of phosphorus such as phosphines, phosphine oxides, phosphonium compounds, phosphates, elementary red phosphorus, phosphites and phosphates. Examples of phosphoric acid compounds that can be mentioned include: monoammonium phosphate, diammonium phosphate, ammonium phosphate, ammonium polyphosphate, melamine phosphate, melamine resin phosphates, potassium phosphate, polyol phosphates such as pentaerythritol phosphate, glycerol phosphate, sorbitol phosphate, mannitol phosphate, dulcitol phosphate, neopentyl glycol phosphate, ethylene glycol phosphate, dipentaerythritol phosphate and the like. The phosphoric acid compound used is preferably a polyphosphate or an ammonium polyphosphate. Melamine resin phosphates are understood to include compounds such as the reaction products of Lamelite C (melamine formaldehyde resin) with phosphoric acid. Examples of sulfuric acid compounds that can be mentioned include ammonium sulfate, ammonium sulfamate, nitroaniline bisulfate, 4-nitroaniline 2-sulfonic acid and 4,4-dinitrosulfanylamide and the like. Melamine borate can be mentioned as an example of a boric acid compound.

Blowing agents used may include the compounds known to those skilled in the art and typically used in fire prevention formulations such as cyanuric acid or isocyanic acid and derivatives thereof, melamine and derivatives thereof. These include cyanamide, dicyanamide, dicyanodiamide, guanidine and salts thereof, biguanide, melamine cyanurate, cyanic acid salts, cyanic acid esters and amides, hexamethoxymethyl melamine, dimelamine pyrophosphate, melamine polyphosphate, melamine phosphate. Hexamethoxymethyl melamine or melamine (cyanuric acid amide) is preferred.

Other components that are also suitable and whose mechanism of action is not limited to a single function include melamine polyphosphate which acts both as an acid forming substance and as a blowing agent. Additional examples are described in GB 2 007 689 A1, EP 139 401 A1 and U.S. Pat. No. 3,969,291 A1.

In one embodiment of the invention, in which the insulating layer is formed by physical intumescence in addition to chemical intumescence, the insulating layer-forming additive also comprises at least one thermally expandable compound such as a graphite intercalation compound which is also known as expanded graphite. These may also be incorporated into the binder.

For example, known intercalation compounds of SOx, NOx, halogen and/or acids in graphite may be considered as expanded graphite. These compounds are also referred to as graphite salts. Expanded graphites which emit SO2, SO3, NO and/or NO2 at temperatures of 120 to 350° C. for example and expand thereby are preferred. The expanded graphite may be present for example in the form of flakes with a maximum diameter in the range of 0.1 to 5 mm. This diameter is preferably in the range of 0.5 to 3 mm. Expanded graphites that are suitable for the present invention are available commercially. In general, the expanded graphite particles in the composition according to the invention are uniformly distributed therein. However, the concentration of expanded graphite particles may be varied in the form of spots, a pattern, a large area and/or a sandwich. In this regard, reference is made to EP 1489136 A1, the contents of which are herewith included in the present patent application.

The ash crust formed in the event of a fire is unstable in many cases and therefore can be blown away due to air currents, for example, depending on the density and structure of the ash crust, and this can have a negative effect on the insulating effect of the coating, so at least one ash crust stabilizer may be added to the components listed above.

The compounds that are generally used in fire prevention formulations and with which those skilled in the art are familiar may be considered as ash crust stabilizers and/or backbone-forming agents, such as expanded graphite and particulate metals such as aluminum, magnesium, iron and zinc. The particulate metal may be in the form of a powder, flakes, chips, fibers, threads and/or whiskers, wherein the particulate metal in the form of powders, flakes or chips will have a particle size of <50 μm, preferably of 0.5 to 10 μm. In the case of using the particular metal in the form of fibers, threads and/or whiskers, a thickness of 0.5 to 10 μm and a length of 10 to 50 μm are preferred. Alternatively, or additionally, an oxide or a compound of a metal from the group comprising aluminum, magnesium, iron or zinc may be used as the ash crust stabilizer, in particular iron oxide, preferably iron trioxide, titanium dioxide, a borate such as zinc borate and/or a glass frit of low-melting glasses with a melting point of preferably 400° C. or higher, phosphate glasses or sulfate glasses, melamine polyzinc sulfates, ferroglasses or calcium borosilicates. Addition of such an ash crust stabilizer contributes toward a significant stabilization of the ash crust in the event of a fire because these additives increase the mechanical strength of the intumescent layer and/or prevent it from dripping off. Examples of such additives can also be found in U.S. Pat. No. 4,442,157 A, U.S. Pat. No. 3,56,197 A, GB 755,551 A as well as EP 138 546 A1.

In addition, ash crust stabilizers, such as melamine phosphate or melamine borate may also be present.

One or more reactive flame retardants may optionally be added to the composition according to the invention. Such compounds are incorporated into the binder. One example in the sense of the present invention would be reactive organophosphorus compounds such as 9,10 dihydro 9 oxa 10 phosphaphenanthrene 10 oxide (DOPO) and its derivatives such as DOPO-HQ, DOPO-NQ and adducts for example. Such compounds are described, for example, in S. V. Levchik, E. D. Weil, Polym. Int. 2004, 53, 1901-1929 or E. D. Weil, S. V. Levchik (eds.), Flame Retardants for Plastic and Textiles—Practical Applications, Hanser, 2009.

The insulating layer-forming additives may be present in an amount of 30 to 99 wt % in the composition, wherein the amount depends essentially on the form of application of the composition (spraying, painting and the like). To achieve the highest possible intumescence rate, the amount of component C in the total formulation is selected to be as high as possible. The amount of component C in the total formulation preferably amounts to 35 to 85 wt % and especially preferably 40 to 85 wt %.

The composition may optionally contain the conventional additives in addition to the insulation layer-forming additives, such as solvents, e.g., xylene or toluene, wetting agents for example those based on polyacrylates and/or polyphosphates, foam suppressants such as silicone foam suppressants, thickeners such as alginate thickeners, dyes, fungicides, plasticizers such as waxes that contain chlorine, binders, flame retardants or various fillers such as vermiculite, inorganic fibers, quartz sand, microglass beads, mica, silicon dioxide, mineral wool and the like.

Additional additives such as thickeners, rheology additives and fillers may also be added to the composition. Rheology additives such as anti-sedimentation aids, anti-runoff aids and thixotropy agents preferably include polyhydroxycarboxylic acid amides, urea derivatives, salts of unsaturated carboxylic acid esters, alkyl ammonium salts of acidic phosphoric acid derivatives, ketoximes, amine salts of p-toluenesulfonic acid, amine salts of sulfonic acid derivatives and aqueous or organic solutions or mixtures of the compounds are used. In addition rheology additives based on pyrogenic or precipitated silicic acids or based on silanized pyrogenic or precipitated silicic acids may also be used. The rheology additive is preferably pyrogenic silicic acid, modified and unmodified layer silicates, precipitated silicic acids, cellulose ethers, polysaccharides, PU and acrylate thickeners, urea derivatives, castor oil derivatives, polyamides and fatty acid amides and polyolefins inasmuch as they are present in solid form, pulverized celluloses and/or suspension agents such as xanthan gum.

The composition according to the invention may be fabricated as a two- or multicomponent system.

Since the reaction occurs at room temperature, the component A and the component B must be kept separate so as to inhibit the reaction. In the presence of a catalyst, it may either be stored separately from components A and B or it may be present in one of these components or divided between the two components. This achieves the result that the two components A and of the binder must first be mixed together immediately prior to use and the curing reaction must be triggered. This makes the system simpler to handle.

In a preferred embodiment of the invention, the composition according to the invention is fabricated as a two-component system wherein the component A and the component B as well as the component A and the component C are arranged separately from one another so as to inhibit the reaction. Accordingly a first component, component I may contain component A while a second component, component II contains components B and C. This achieves the result that the two components A and B and/or C of the binder are mixed together only immediately prior to use and thereby trigger the curing reaction. This makes the system simpler to handle.

Component D may be divided into individual components or used as a mixture and may be present in the first component I and/or the second component II. Component D is divided as a function of the tolerability of the compounds contained in the composition, so that there is neither a reaction of the components contained in the composition with one another nor is there a mutual interference or any reaction of these compounds with the compounds of the other components. This depends on the compounds used. This ensures that the greatest possible amount of fillers can be achieved. This results in a high intumescence, even with low layer thicknesses of the composition.

The composition is applied to the substrate, in particular a metallic substrate, as a paste using a brush, a roller or by spraying on to the substrate. The composition is preferably applied by means of an airless spraying method.

In comparison with the solvent-based and water-based systems, the composition according to the invention is characterized by a relative rapid curing due to an addition reaction and therefore the lack of a need for drying. This is very important in particular when the coated parts must be exposed to loads quickly and/or processed further, whether by coating with a top coat or overall due to movement or transport of the parts. The coating is thus much less susceptible to external influences at the construction site such as exposure to (rain) water and dirt and dust, which in the case of solvent-based or water-based systems, may result in the water-soluble components such as the ammonium polyphosphate being leached out and/or may result in uptake of dust leading to reduced intumescence. Due to the low viscosity of the composition despite the high solids content, the composition remains easy to process, in particular by conventional spray methods. Based on the low softening point of the binder and the high solids content, the rate of expansion under exposure to heat is high even with a small layer thickness.

In addition, a dried layer of the composition according to the invention has a very high water fastness with respect to salt water in comparison with the usual water-based or solvent-based systems. Therefore, the composition according to the invention is suitable as a coating, in particular as a fire prevention coating, preferably a sprayable coating for substrates on a metallic and nonmetallic basis. The substrates are not limited and also include parts in particular steel parts and wooden part but also individual cables, cable bundles, cable trees and cable ducts or other lines.

The composition according to the invention is used primarily in the construction field as a coating, in particular as a fire prevention coating for steel construction elements, but also for construction elements made of other materials such as concrete or wood as well as fire prevention coatings for individual cables, cable bundles, cable trees and cable ducts or other lines.

Another subject matter of the present invention is therefore the use of the composition according to the invention as a coating, in particular as a coating for construction elements or components made of steel, concrete, wood and other materials such as plastics, in particular as a fire prevention coating.

The present invention also relates to objects obtained when the composition according to the invention is cured. These objects have excellent insulation layer-forming properties.

The following examples are used to further illustrate the present invention.

### EMBODIMENTS

For production of inventive insulation layer-forming compositions, the individual components are combined and homogenized with the help of a dissolver as described below.

The curing behavior was observed in each case and then the intumescence factor was determined and the relative ash crust stability was determined. To do so the compositions were each placed in a round PTFE mold with a diameter of 48 mm.

The curing time corresponds to the time after which the samples were nontacky and could be removed from the Teflon mold.

To determine the intumescence factor and the relative ash crust stability, a muffle furnace was preheated to 600° C. Multiple measurements of the sample thickness were performed using the graduated caliper and the average hM was calculated. Then the samples were each placed in a cylindrical steel mold and heated for 30 minutes in a muffle furnace. After cooling to room temperature, the foam height hE1 was determined initially by a nondestructive method. The intumescence factor I is calculated as follows:

i=hE1:hM Intumescence factor I:

Next a defined weight (m=105 g) in the cylindrical steel mold was dropped from a defined height (h=100 mm) onto the foam and the foam height hE2 remaining after this partially destructive action was determined. The relative ash crust stability was then calculated as follows:

ACS=hEZ:hE1 Relative ash crust stability (ACS):

In the following examples, the following composition was used as component D.

### Component D:

| Component | Amount (g) |
|---|---|
| Pentaerythritol | 8.7 |
| Melamine | 8.7 |
| Ammonium polyphosphate | 16.6 |
| Titanium dioxide | 7.9 |

### Comparative Example 1

A reactive system based on polyurethane with the following composition was used for comparison purposes:

### Component 1

| Compounds | Amount (g) |
|---|---|
| Polyol¹ | 100.0 |

¹Desmophen ® 1150, branched polyol based on castor oil; viscosity (23° C.) 3500 ± 500 mPa · s (DIN EN ISO 3219/A.3)

### Component 2

| Compounds | Amount (g) |
|---|---|
| Diphenylmethane diisocyanate (MDI)² | 45.0 |

²Desmodur VL, aromatic polyisocyanate based on diphenylmethane diisocyanate; viscosity (23° C.) 90 ± 20 mPa · s; NCO equivalent weight approx. 133 g/eq

### Component D:

| Compounds | Amount (g) |
|---|---|
| as indicated above | 163.0 |

### Comparative Example 2

A commercial fire prevention product (Hilti CFP S-WB) based on an aqueous dispersion technology was used for the sake of comparison.

### Comparative Example 3

As a further comparison, a standard epoxy-amine system (Jeffamin® T-403, liquid solvent-free and crystallization-stable epoxy resin consisting of low-molecular epoxy resins based on bisphenol A and bisphenol F (Epilox® AF 18-30, Leuna-Harze GmbH) and 1,6-hexanediol diglycidyl ether) which is 60% filled with an intumescence mixture as in the above examples.

### Comparative Example 4

A standard epoxy-amine system (isophorone diamine, trimethylolpropane triacrylate and liquid solvent-free and crystallization-stable epoxy resin consisting of low-molecular epoxy resins based on bisphenol A and bisphenol F (Epilox® AF 18-30, Leuna-Harze GmbH)) which was 60% filled with an intumescence mixture similar to that in the above examples was used as an additional comparison.

### Comparative Example 5

A reactive system with the following composition, which was prepared by methods similar to that described in the patent application EP 13170748 that was not published previously was used as an additional comparison:

### Component 1

| Compounds | Amount (g) |
|---|---|
| Amine-functionalized resin³ | 18.2 |
| Dispersing additive⁴ | 1.1 |

³Desmophen ® NH 1420; viscosity (25° C.) 900-2000 mPa · s; amine value 199-203; equivalent weight 279
⁴Disperbyk-111

### Component 2

| Compounds | Amount (g) |
|---|---|
| Aliphatic polyisocyanate resin based on | 6.0 |
| hexamethylene diisocyanate⁵ | |
| Aliphatic prepolymer based on hexamethylene | 23.0 |
| diisocyanate⁶ | |

⁵Desmodur ® N 3900; NCO content 23.5 ± 0.5 wt % (DIN EN ISO 11 909); viscosity (23° C.) 730 ± 100 mPa · s (DIN EN ISO 3219/A.3); NCO equivalent weight approx. 179 g
⁶Desmodur XP 2599; NCO content 6 ± 0.5 wt %; viscosity (23° C.) 2500 ± 500 mPa · s; NCO equivalent weight approx. 700 g

### Component D:

| Compounds | Amount (g) |
|---|---|
| same as indicated above | 72.2 |

### Example 1

### Components B and C

| Compounds | Amount (g) |
|---|---|
| Amine-functionalized resin⁷ | 17.6 |
| Glycol di(3-mercaptopropionate)⁸ | 7.6 |

⁷Desmophen ® NH 1420; viscosity (25° C.) 900-2000 mPa · s; amine value 199-203; equivalent weight 279 g/eq
⁸Thiocure GDMP, Bruno Bock Chemische Fabrik GmbH & Co. KG

### Component A

| Compounds | Amount (g) |
|---|---|
| Aliphatic polyisocyanate resin based on | 22.9 |
| hexamethylene diisocyanate⁹ | |

⁹Desmodur ® N 3900; NCO content 23.5 ± 0.5 wt % (DIN EN ISO 11 909); viscosity (23° C.) 730 ± 100 mPa · s (DIN EN ISO 3219/A.3); equivalent weight approx. 179 g/eq

### Component D

| Compounds | Amount (g) |
|---|---|
| as indicated above | 72.1 |

### Example 2

### Components B and C

| Compounds | Amount (g) |
|---|---|
| Amine-functionalized resin¹⁰ | 8.4 |
| Ethoxylated trimethylolpropane tri-3-mercaptopropionate¹¹ | 7.3 |
| Polyethylene glycol¹² | 8.8 |

¹⁰Desmophen NH 1420; viscosity (25° C.) 900-2000 mPa · s; amine value 199-203; equivalent weight 279 g/eq
¹¹Thiocure ETTMP 700; Bruno Bock Chemische Fabrik GmbH & Co. KG; viscosity approx. 200 mPa · s (ISO 2555, Brookfield Spindel S62, 20 rpm); H equivalent weight 236-262 g/eq; mercaptosulfur (SH) 12.2-15.0 wt % (iodometric, PA-QW-303)
¹²Polyglycol 600

### Component A

| Compounds | Amount (g) |
|---|---|
| Aliphatic polyisocyanate resin based on | 16.0 |
| hexamethylene diisocyanate¹³ | |

¹³Desmodur ® N 3600; viscosity (25° C.) 1100 ± 300 mPa · s; NCO content 23.0 ± 0.5%; equivalent weight 183 g/eq

### Component D

| Compounds | Amount (g) |
|---|---|
| as indicated above | 60.0 |

### Example 3

### Components B and C

| Compounds | Amount (g) |
|---|---|
| Amine-functionalized resin¹⁴ | 8.4 |
| Ethoxylated trimethylol tri-3-mercaptopropionate¹⁵ | 7.1 |
| Polyethylene glycol¹⁶ | 8.8 |

¹⁴Desmophen NH 1520; viscosity (25° C.) 800-2000 mPa · s; amine value 189-193; equivalent weight 290 g/eq
¹⁵Thiocure ETTMP 700; Bruno Bock Chemische Fabrik GmbH & Co. KG; viscosity approx. 200 mPa · s (ISO 2555, Brookfield Spindel S62, 20 rpm); H equivalent weight 236-262 g/eq; mercaptosulfur (SH) 12.2-15.0 wt % (iodometric, PA-QW-303)
¹⁶Polyglycol 600

### Component A

| Compounds | Amount (g) |
|---|---|
| Aliphatic polyisocyanate resin based on | 15.9 |
| hexamethylene diisocyanate¹⁷ | |

¹⁷Desmodur N 3600; viscosity (25° C.) 1100 ± 300 mPa · s; NCO content 23.0 ± 0.5%; equivalent weight 183 g/eq

### Component D

| Compounds | Amount (g) |
|---|---|
| as indicated above | 60.1 |

### Example 4

### Components B and C

| Compounds | Amount (g) |
|---|---|
| Amine-functionalized resin¹⁸ | 9.8 |
| Glycol di(3-mercaptopropionate)¹⁹ | 12.8 |

¹⁸Desmophen ® NH 1420; viscosity (25° C.) 900-2000 mPa · s; amine value 199-203; equivalent weight 279 g/eq
¹⁹Thiocure GDMP; Bruno Bock Chemische Fabrik GmbH & Co. KG

### Component A

| Compounds | Amount (g) |
|---|---|
| Aliphatic polyisocyanate resin based on | 25.5 |
| hexamethylene diisocyanate²⁰ | |

²⁰Desmodur ® N 3900; NCO content 23.5 ± 0.5 wt % (DIN EN ISO 11 909); viscosity (25° C.) 730 ± 100 mPa · s (DIN EN ISO 3219/A.3); equivalent weight approx. 179 g/eq

### Component D

| Compounds | Amount (g) |
|---|---|
| as indicated above | 72.1 |

The results presented in Table 1 show clearly that curing of the compositions according to the invention takes place more rapidly than that of the comparative compositions.

TABLE 1
Results of the measurement of the curing time

| | Sample thickness h_{A} | | |
|---|---|---|---|
| Example | (mm) | Curing time | |
| 1 | 4.5 | 35 | min |
| 2 | 3.4 | 30 | min |
| 3 | 3.3 | 45 | min |
| 4 | 5.5 | 4.5 | min |
| Comparative | 1.8 | 10 | days |
| example 2 | | | |
| Comparative | 5.1 | 2.25 | h |
| example 5 | | | |

TABLE 2
Results of measurements of the intumescence factor and
the ash crust stability

| | | Relative ash crust | Sample |
|---|---|---|---|
| | Intumescence | stability AKS | thickness h_{M} |
| Example | factor I (multiple) | (multiple) | (mm) |
| 1 | 5.5 | 0.81 | 4.5 |
| 2 | 5.1 | 0.84 | 3.4 |
| 3 | 3.9 | 0.78 | 3.3 |
| 4 | 9.9 | 0.86 | 5.5 |
| Comparative | Sample decomposes, no intumescence | | 1.4 |
| example 1 | | | |
| Comparative | 22 | 0.04 | 1.6 |
| example 3 | | | |
| Comparative | 1.7 | 0.60 | 1.2 |
| example 4 | | | |
| Comparative | 4.8 | 0.76 | 5.1 |
| example 5 | | | |

1. An insulation layer-forming composition comprising a constituent A, which contains an isocyanate compound; a constituent B, which contains a reactive component that reacts with isocyanate compounds and is selected from compounds having at least two amino groups, wherein the amino groups are primary and/or secondary amino groups, independently of one another; a constituent C, which contains a thiol-functionalized compound; and a constituent D, which contains an insulation layer-forming additive, wherein the insulation layer-forming additive comprises a mixture, optionally containing at least one carbon source, at least one dehydrogenation catalyst and at least one blowing agent.

2. The insulation layer-forming composition according to claim 1, wherein the reactive component that reacts with the isocyanate compounds is selected from polyamines, polyether polyamines and polyaspartic acid esters or a mixture thereof.

3. The insulation layer-forming composition according to claim 2, wherein the reactive component that reacts with isocyanate compounds is a polyether polyamine, which is selected from compounds of general formula (I) 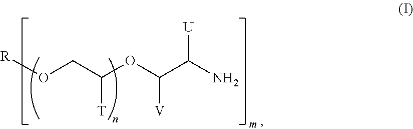
wherein
R is the radical of an initiator for alkoxylation with 2 to 12 carbon atoms and 2 to 8 groups with active hydrogens,
T is hydrogen or a C₁-C₄ alkyl group,
V and U, independently of one another, are hydrogen or T,
n is a value between 0 and 100,
m is an integer between 2 and 8, where m corresponds to the number of groups with an active hydrogen that were originally contained in the initiator for alkoxylation.

4. The insulation layer-forming composition according to claim 2, wherein the reactive component that reacts with isocyanate compounds is a polyaspartic acid ester of general formula (VII): 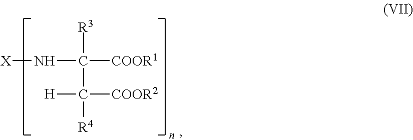
wherein
R¹ and R² are the same or different and stand for organic radicals that are inert with respect to isocyanate groups,
R³ and R⁴ are the same or different and stand for hydrogen or organic radicals that are inert with respect to isocyanate groups,
X stands for an n-valent organic radical that is inert with respect to isocyanate groups and n stands for an integer of at least 2.

5. The insulation layer-forming composition according to claim 4, wherein R¹ and R² in formula (VII) stand for a methyl group or ethyl group independently of one another, and R³ and R⁴ each stand for hydrogen.

6. The insulation layer-forming composition according to claim 4, wherein X in formula (VII) stands for a radical, obtained by removing the primary amino groups from an aliphatic polyamine.

7. The insulation layer-forming composition according to claim 6, wherein X stands for a radical obtained by removing the primary amino groups from 1,4-diaminobutane, 1,6-diaminohexane, 2,2,4- or 2,4,4-trimethyl-1,6-diaminohexane, 1-amino-3,3,5-trimethyl-5-aminomethylcyclohexane, 4,4′-diaminodicyclohexylmethane or 3,3′-dimethyl-4,4′-diaminodicyclohexylmethane, diethylene triamine and triethylene tetramine, and n stands for the number 2.

8. The insulation layer-forming composition according to claim 1, wherein constituent B also contains a polyol compound.

9. The insulation layer-forming composition according to claim 8, wherein the polyol compound is selected from polyester polyols, polyether polyols, hydroxylated polyurethanes and/or alkanes each with at least two hydroxyl groups per molecule.

10. The insulation layer-forming composition according to claim 9, wherein the polyol compound is selected from compounds comprising a basic backbone of polyester, polyether, polyurethane and/or alkanes or mixtures thereof and one or more hydroxyl groups.

11. A composition according to claim 1, wherein the one or more thiol groups of the at least one thiol-functionalized compound are bound to a monomer, an oligomer or a polymer as the backbone.

12. The insulation layer-forming composition according to claim 1, wherein the isocyanate compound is an aliphatic or aromatic basic backbone and comprises at least two isocyanate groups or a mixture of isocyanate groups.

13. The insulation layer-forming composition according to claim 1, wherein quantity ratios of constituents A and B are selected so that an equivalent ratio of isocyanate groups of the isocyanate compound to the groups that are reactive with the isocyanate group of the reactive component that reacts with isocyanate compounds is between 0.3 and 1.7.

14. The composition according to claim 1, also containing a catalyst for the reaction between the isocyanate compound and the reactive components that are reactive with the isocyanate compounds and/or with the polyol.

15. The composition according to claim 1, wherein the insulation layer-forming additive also comprises at least one thermally expandable compound.

16. The composition according to claim 1, wherein the insulation layer-forming additive also contains an ash crust stabilizer.

17. The composition according to claim 1, wherein the composition also contains organic and/or inorganic aggregates and/or additional additives.

18. (canceled)

19. A coating comprising the composition of claim 1.

20. The coating according to claim 19 for coating steel construction elements.

21. The coating according to claim 19 for coating metallic and nonmetallic substrates.

22. A fire prevention layer comprising the coating of claim 19.

23. A mutlticomponent system comprising:
the insulation layer-forming composition of claim 1, wherein constituent A and constituent B are kept separately and mixed together immediately before use.

24. A two-component system comprising:
the insulation layer-forming composition of claim 1,
wherein component I comprises constituent A,
and component II comprises constituents B and C,
wherein constituent A and constituent B, and constituent A and constituent C, are arranged separately, and constituent A and constituent B and/or constituent C are mixed together immediately before use.
